(19) United States
(12) Patent Application Publication
(10) Pub. No.: US 2016/0169685 A1
(43) Pub. Date: Jun. 16, 2016

(54) AVN TERMINAL AND CONTROL METHOD THEREOF, WEARABLE DEVICE AND CONTROL METHOD THEREOF, AND COMPUTER READABLE RECORDING MEDIUM

(71) Applicant: HYUNDAI MOTOR COMPANY, Seoul (KR)

(72) Inventor: Keun hang HEO, Yongin-si (KR)

(21) Appl. No.: 14/704,953

(22) Filed: May 5, 2015

(30) Foreign Application Priority Data
Dec. 11, 2014 (KR) 10-2014-0178326

(51) Int. Cl. G01C 21/26; G01C 21/36; B60R 25/20; G01S 19/13; B60R 16/037

(52) U.S. Cl. CPC G01C 21/26; G01S 19/13; B60R 16/037; B60R 25/209; G01C 21/36

(57) ABSTRACT

An audio video navigation (AVN) terminal is disclosed. The terminal includes an interface unit configured to communicate with a wearable device, and a controller configured to determine a position of the wearable device and to provide a service based on the position. The terminal provides improved user convenience.

### CROSS REFERENCE TO RELATED APPLICATION

This application claims the benefit of Korean Patent Application No. P10-2014-0178326, filed on Dec. 11, 2014 with Korean Intellectual Property Office, which is hereby incorporated by reference as if fully set forth herein.

### BACKGROUND OF THE INVENTION

1. Field of the Invention

The present invention relates to an audio video navigation (AVN) terminal and a control method thereof, a wearable device and a control method thereof, and a computer readable recording medium and, more particularly, to an AVN terminal for better user convenience and a control method thereof, a wearable device and a control method thereof, and a computer readable recording medium.

2. Discussion of the Related Art

Rapid development of electronic control technology allows a variety of devices of a vehicle, which have conventionally been mechanically operated, to be electrically driven for driver convenience, driving safety, and the like. A system of a vehicle is being gradually advanced and becoming state-of-the-art. Particularly, technology in-vehicle technology is continuously improving.

An audio video navigation (AVN) terminal may be incorporated in a vehicle to provide audio, video, and navigation functions. In addition, the AVN terminal may perform communication with a telematics unit via controller area network (CAN) communication, or may be integrally equipped with a telematics unit. In addition, the AVN terminal may be equipped with a display to provide visual information to a user.

The AVN terminal may be controlled through a smart terminal connected thereto. The related art discloses a feature in which a smart terminal receives a user command through a graphical user interface (GUI) thereof to control an AVN terminal via Bluetooth communication.

There is a need to develop technology for providing different services according to a position of a smart terminal.

### SUMMARY OF THE INVENTION

Accordingly, the present invention is directed to an AVN terminal and a control method thereof, a wearable device and a control method thereof, and a computer readable recording medium that substantially obviate one or more problems due to limitations and disadvantages of the related art.

An object of the present invention is to provide an AVN terminal capable of providing various services according to a position of a vehicle passenger and a control method thereof, a wearable device and a control method thereof, and a computer readable recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the present invention provides an AVN terminal including an interface unit configured to communicate with a wearable device and a controller configured to determine a position of the wearable device and to provide a service based on the position.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an AVN terminal according to an embodiment of the present invention;

FIG. 2 is a perspective view showing a configuration of a wearable device according to an embodiment of the present invention;

FIG. 3 shows steps of an AVN terminal control method according to an embodiment of the present invention;

FIG. 4 is a view showing the interior of a vehicle according to an embodiment of the present invention;

FIG. 5 is a view showing content displayed on a wearable device when a wearable device is at the outside of a vehicle according to an embodiment of the present invention;

FIG. 6 is a view showing content displayed on an AVN terminal according to an embodiment of the present invention;

FIG. 7 is a view showing content displayed on an AVN terminal when a wearable device is located at a rear seat of a vehicle according to an embodiment of the present invention; and

FIG. 8 is a view showing content displayed on a wearable device when a wearable device is located at a rear seat of a vehicle according to an embodiment of the present invention.

### DETAILED DESCRIPTION OF THE INVENTION

Hereinafter, reference will now be made in detail to the preferred embodiments of the present invention, examples of which are illustrated in the accompanying drawings. In the drawings, the same or similar elements are denoted by the same reference numerals even though they are depicted in different drawings, and a detailed description of the same or similar elements will be omitted. The suffixes “module” and “unit” of elements herein are used for convenience of description and thus can be used interchangeably and do not have any distinguishable meanings or functions. In addition, in the following description of the embodiments disclosed herein, a detailed description of related known technologies will be omitted when it may make the subject matter of the embodiments disclosed herein rather unclear. In addition, the accompanying drawings have been made only for a better understanding of the embodiments disclosed herein and are not intended to limit technical ideas disclosed herein, and it should be understood that the accompanying drawings are intended to encompass all modifications, equivalents and substitutions included in the sprit and scope of the present invention,

The terms including “first,” “second,” and the like may be used to describe various elements, but the elements are not limited by the terms. The terms, if any, are used for distinguishing between one element and other elements.

It will be understood that when one element is referred to as being “connected to” or “accessed by” another element, one element may be “connected to” or “accessed by” another element via a further element although one element may be directly connected to or directly accessed by another element. On the other hand, it will be understood that when one element is referred to as being “directly connected to” or “directly accessed by” another element, there is no component between the mentioned elements.

The singular forms are intended to include the plural forms as well, unless the context clearly indicates otherwise.

The term “comprises” or “has” described herein should be interpreted not to exclude presence or addition possibility of characteristics, numbers, steps, operations, constituent elements, parts or combinations thereof described in the specification but to designate presence of one or more other characteristics, numbers, steps, operations, constituent elements, parts or combinations thereof.

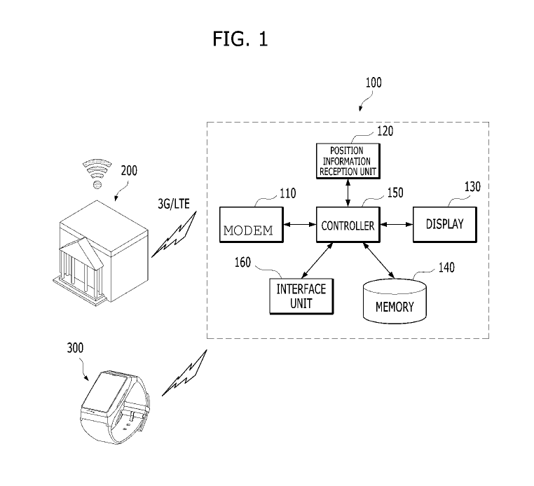

FIG. 1 is a block diagram of an AVN terminal according to an embodiment of the present invention.

Referring to FIG. 1, the AVN terminal, designated by reference numeral 100, may be mounted in a vehicle and perform communication with a telematics center 200 and a wearable device 300.

The AVN terminal 100 may include a modem 110, a position information reception unit 120, a display 130, a memory 140, a controller 150, and an interface unit 160.

The modem 110 may include one or more modules to enable wireless communication between the AVN terminal 100 and a wireless communication system, between the AVN terminal 100 and another AVN terminal, or between the AVN terminal 100 and an external center. In addition, the modem 110 may include one or more modules to connect the AVN terminal 100 to one or more networks.

The modem 110 may perform communication with the telematics center 200. Generally, the modem 110 may perform communication with the telematics center 200 using wireless communication. The modem 110 may transmit and receive radio signals to and from at least one of a base station, an external terminal, and the telematics center 200 via a mobile communication network that is constructed according to technical standards for mobile communication or communication methods (e.g., global system for mobile communication (GSM), code division multi access (CDMA), code division multi access 1000 (CDMA1000), enhanced voice-data optimized or enhanced voice-data only (EV-DO), wideband CDMA (WCDMA), high speed downlink packet access (HSDPA), high speed uplink packet access (HSUPA), long term evolution (LTE), and long term evolution-advanced (LTE-A)). The radio signals may include various types of data based on transmission/reception of voice call signals, video call signals, and letters/multimedia messages.

The position information reception unit 120 serves to acquire a position (or current position) of the AVN terminal 100. For example, a position of the AVN terminal 100 may be acquired as the position information reception unit 120 receives position signals transmitted from GPS satellites.

While the AVN terminal 100 is described herein as including the modem 110 and the position information reception unit 120, in some embodiments, the AVN terminal 100 may include an in-vehicle unit (not shown) including a modem and a separate position information reception unit 120. At this time, the in-vehicle unit may perform communication with the position information reception unit 120 via in-vehicle communication, such as CAN communication.

The display 130 may include at least one selected from among a liquid crystal display (LCD), a thin film transistor-liquid crystal display (TFT-LCD), an organic light emitting diode (OLED), a flexible display, a three-dimensional (3D) display, and e-ink display.

The display 130 may include a touch sensor to sense a touch to the display 130 so as to receive a control command in a touch manner. As such, upon occurrence of a touch to the display 130, the touch sensor may sense the touch and the controller 150 may generate a control command corresponding to the touch. Content input via touch may be letters or numerals, or menu items that may be indicated or designated in various modes.

The memory 140 stores data to assist various functions of the AVN terminal 100. The memory 140 may store a number of applications that are driven in the AVN terminal 100, and data and commands for operation of the AVN terminal 100. At least some applications may be downloaded from an external center via wireless communication. In addition, at least some applications may be preinstalled in the AVN terminal 100 for basic functions of the AVN terminal 100. Meanwhile, the applications may be stored in the memory 140 and installed in the AVN terminal 100 so as to be driven by the controller 150 to perform operation (or functions) of the AVN terminal 100.

The memory 140 may include at least one storage medium selected from among a flash memory type memory, a hard disk type memory, a solid state disk (SSD) type memory, a silicon disk drive (SDD) type memory, a multimedia card micro type memory, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The AVN terminal 100 may be operated in connection with a web storage that performs a storage function of the memory 140 in the Internet.

The controller 150 typically controls general operations of the AVN terminal 100 in addition to operations related to the applications. The controller 150 may process signals, data, and information input or output via the aforementioned components, or drive applications stored in the memory 140, thereby providing or processing information or functions suitable for a user.

The controller 150 may receive current position information of the AVN terminal 100 via the position information reception unit 120. The current position information may be acquired via GPS reception.

The interface unit 160 may perform communication with the wearable device 300. For example, the interface unit 160 may communicate with the wearable device 300 via wired communication, such as universal serial bus (USB) communication or serial communication, or via wireless communication, such as Bluetooth communication or Wi-Fi communication.

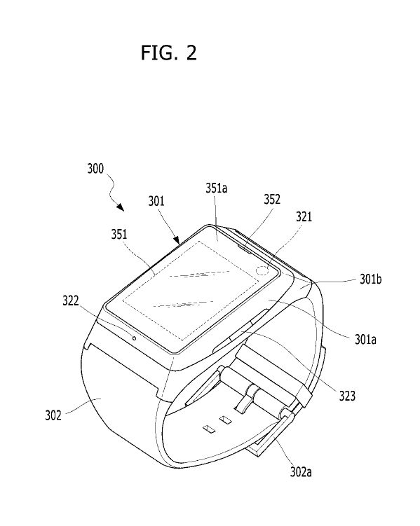

FIG. 2 is a perspective view showing a configuration of a wearable device according to an embodiment of the present invention.

Referring to FIG. 2, a mobile terminal 300 in the form of a watch includes a main body 301 having a display unit 351, and a band 302 connected to the main body 301 so as to be worn around a wrist.

The main body 301 includes a case defining an external appearance. As shown, the case may include a first case 301a and a second case 301b which define an inner space for accommodation of a variety of electronic components. It will be appreciated that the present invention is not limited thereto and a single case may define the inner space to achieve a uni-body type mobile terminal 300.

The watch type mobile terminal 300 is configured to enable wireless communication, and the main body 301 may be provided with an antenna for wireless communication. Meanwhile, the antenna may expand performance thereof using a case. For example, a case formed of a conductive material may be electrically connected to the antenna to expand a ground region or radiation region.

The display unit 351 may be located at a front surface of the main body 301 to output information. The display unit 351 may have a touch sensor and take the form of a touchscreen. As shown, a window 351a of the display unit 351 may be mounted to the first case 301a to define, along with the first case 301a, a front surface of a terminal body.

The main body 301 may be provided with a sound output unit 352, a camera 321, a microphone 322, and a user input unit 323. When the display unit 351 is a touchscreen, the display unit 351 may function as the user input unit 323 and the main body 301 may have no key.

The band 302 is worn around the wrist to surround the wrist and may be formed of a flexible material for easy wearing. For example, the band 302 may be formed of leather, rubber, silicon, or synthetic resins. In addition, the band 302 is separably coupled to the main body 301 and is replaceable with various shapes of bands according to user taste.

Meanwhile, the band 302 may be used to expand performance of the antenna. For example, the band may include a ground expander (not shown) that is electrically connected to the antenna to expand a ground region.

The band 302 may include a fastener 302a. The fastener 302a may be a buckle, a snap-fittable hook, or Velcro™, and may include an elastic section or material. The drawing shows an example in which the fastener 302a takes the form of a buckle.

In addition, the wearable device 300 may include a modem (not shown) and a controller (not shown). The modem is a module for communication with the AVN terminal 100, and the controller is a module to control general operations of the wearable device 300.

Meanwhile, a control method of an AVN terminal that is in communication connection with a wearable device will be described below.

Control Method of AVN Terminal that is in Communication Connection with Wearable Device

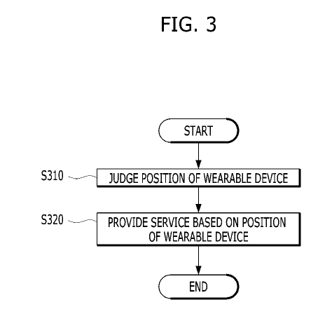

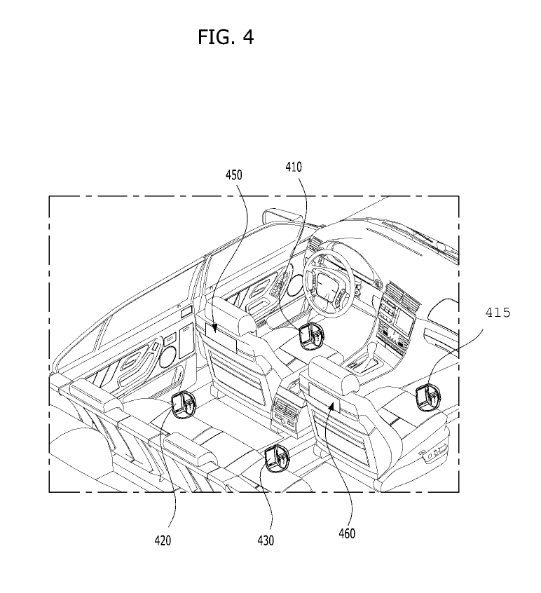

FIG. 3 shows steps of an AVN terminal control method according to an embodiment of the present invention, and FIG. 4 is a view showing the interior of a vehicle according to an embodiment of the present invention. A description of FIG. 3 will follow with reference to FIG. 4.

First, the controller 150 determines a position of a wearable device (S310).

Upon establishing communication between the wearable device 300 and the AVN terminal 100, the controller 150 may determine where the wearable device is located.

The AVN terminal 100 may determine a position of the wearable device via indoor GPS technology or Bluetooth low energy (BLE) technology. For example, the AVN terminal 100 may determine a position of a device having a Bluetooth function within a short distance via BLE-based beacon technology.

Here, to determine a position of the wearable device, the controller 150 may first perform communication with the wearable device.

Meanwhile, the controller 150 may determine a position of a passenger based on information input through a weight sensor mounted in a seat.

Next, the controller 150 provides a service based on the position of the wearable device (S320).

In a case in which the wearable device 300 is located at the outside of a vehicle, the controller 150 may await reception of a remote control command. For example, the remote control command may include at least one of a remote start command, a remote air conditioning command, and remote door lock/unlock commands. In addition to the aforementioned remote control commands, the controller 150 may receive various other remote control commands from the wearable device 300.

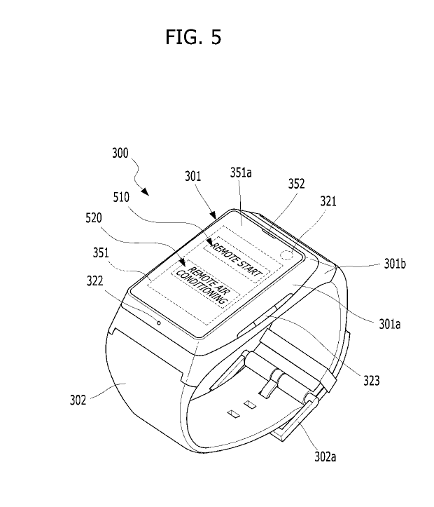

In this case, as exemplarily shown in FIG. 5, the wearable device 300 may display some remote control commands. That is, the wearable device 300 may receive a notice notifying that the wearable device 300 is at the outside of the vehicle, from the AVN terminal 100, and display a UI corresponding to the received notice. Then, the wearable device 300 may transmit a remote control command to the AVN terminal 100 in response to user input (e.g., touch input).

Returning to FIG. 3, the controller 150 may provide various services based on the position of the wearable device 300.

In a case in which the wearable device 300 is located at a driver seat of the vehicle (410 of FIG. 4), the controller 150 may determine that a passenger who wears the wearable device 300 is located at the driver seat.

At this time, when a destination is set in the AVN terminal 100, the controller 150 may provide a service to guide the way to the destination. Note that this case is provided according to one embodiment and various other embodiments may be applied. For example, in a case in which the wearable device 300 is located at the driver seat, the controller 150 may provide a multimedia service, may provide a safe driving notification service, and may provide a weather information service.

In addition, in a case in which the wearable device 300 is located at a passenger seat of the vehicle (415 of FIG. 4), the controller 150 may provide a multimedia service. Likewise, this case is provided according to one embodiment and various other embodiments may be applied.

In addition, in a case in which the wearable device 300 is located at a rear seat of the vehicle (420 and 430 of FIG. 4), the controller 150 may power ON rear seat entertainment (RSE) terminals 450 and 460 corresponding to the rear seat and provide a predetermined service through the RSE terminals 450 and 460.

For example, in a case in which the wearable device 300 is located at a VIP rear seat (430 of FIG. 4), the controller 150 may power ON the RSE terminal 460 via in-vehicle communication, such as CAN communication.

At this time, the RSE terminal 460 may provide a passenger with a predetermined service (e.g., a multimedia service).

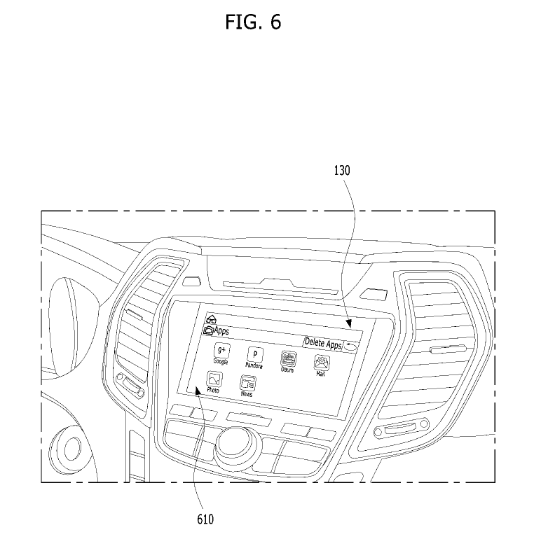

Here, the controller 150 of the AVN terminal 100 may control the display 130 of the AVN terminal 100 to display content in a simple mode. This will be described below with reference to FIGS. 6 to 8.

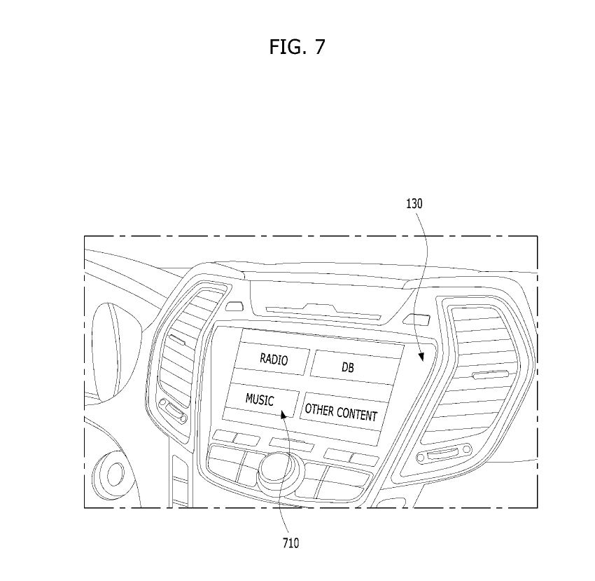

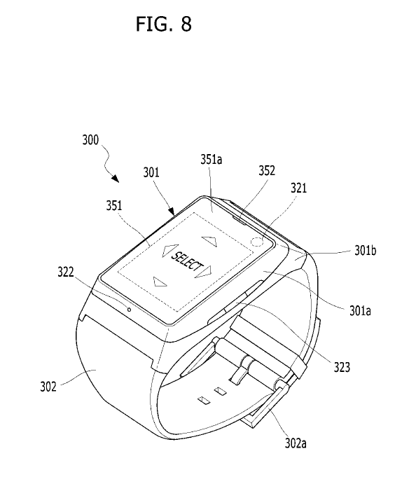

The controller 150 may display content as exemplarily shown in FIG. 6 until the wearable device 300 is detected at a rear seat. However, when the wearable device 300 is detected at a rear seat, content may be displayed in brief as exemplarily shown in FIG. 7. In addition, as exemplarily shown in FIG. 8, the wearable device 300 may operate like a remote controller to receive user input for selection of brief content displayed on the AVN terminal 100.

That is, the controller 150 may control the AVN terminal 100 as exemplarily shown in FIG. 7 to allow a user who rides on a rear seat to easily control the AVN terminal 100, and the wearable device 300 may control items to be displayed on the wearable device 300 as exemplarily shown in FIG. 8.

For example, in a case in which the wearable device 300 is located at a rear seat, the controller 150 may display a radio item, a music item, a DB item, and other content items as exemplarily shown in FIG. 7. Assuming that an initial position of a cursor is the radio item. At this time, when a rightward cursor is selected on the wearable device 300, the controller 150 may control the AVN terminal 100 to allow the cursor to be located at the DB item.

In a case in which the wearable device 300 is located at a rear seat as described above, it is possible to allow a user who rides on the rear seat to more conveniently use the AVN terminal 100, which may result in improved user convenience.

In addition, the wearable device 300 may transmit a control command to the AVN terminal 100 using a swiping or gesture recognition sensor, in addition to using the displayed cursor.

Although not shown in the drawings, when two or more wearable devices 300 are detected inside the vehicle by the AVN terminal 100, the AVN terminal 100 may be able to sequentially provide aforementioned services based on predetermined priority of the positions of the two or more wearable devices 300. For example, a wearable device 300 at the driver seat 410 has first priority, a wearable device 300 at the passenger seat 415 has second priority, a wearable device 300 at the left rear seat 420 has third priority, and a wearable device 300 at the right rear seat 430 has lowest priority.

Meanwhile, in a computer readable recording medium including a program to execute the control method of the AVN terminal according to one embodiment of the present invention, the control method may include determining a position of a wearable device and providing a service based on the position. The computer readable medium includes all kinds of recording devices in which data that may be read by a computer system is stored. Examples of the computer readable medium may include a hard disk drive (HDD), a solid state disk (SSD), a silicon disk drive (SDD), ROM, a RAM, a CD-ROM, a magnetic tape, a floppy disk, and an optical data storage device. In addition, the computer readable recording medium includes a carrier wave (e.g., data transmission over the Internet). In addition, the computer may include the controller 150 of the AVN terminal 100. Accordingly, the above detailed description is not intended to be construed to limit the present invention in all aspects and be considered by way of example. The scope of the present invention should be determined by reasonable interpretation of the accompanying claims and all equivalent modifications made without departing from the present invention should be included in the following claims.

As is apparent from the above description, according to various embodiments of the present invention, improved user convenience may be accomplished through provision of various services based on a position of a vehicle passenger.

In addition, improved user convenience may be accomplished through provision of different display items of an AVN terminal according to a position of a wearable device.

It will be appreciated by persons skilled in the art that the effects that can be achieved through the present invention are not limited to what has been particularly described hereinabove and other advantages of the present invention will be more clearly understood from the above detailed description.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A control method of an audio video navigation (AVN) terminal, the method comprising steps of:
determining a position of a wearable device; and
providing a service based on the position of the wearable device.

2. The control method according to claim 1, further comprising awaiting reception of a remote control command when the wearable device is determined at the outside of a vehicle.

3. The control method according to claim 2, wherein the remote control command includes at least one of a remote start command, a remote air conditioning command, and remote door lock and unlock commands.

4. The control method according to claim 1, wherein the step of providing includes providing a guide service to guide the way to a destination when the wearable device is determined at a driver seat of a vehicle and the destination is set in the AVN terminal.

5. The control method according to claim 1, wherein the step of providing includes providing a multimedia service when the wearable device is determined at a passenger seat of a vehicle.

6. The control method according to claim 1, wherein the step of providing includes powering ON a rear seat entertainment (RSE) terminal corresponding to a rear seat of a vehicle when the wearable device is determined at the rear seat.

7. The control method according to claim 1, wherein the step of providing includes displaying content in a simple mode when the wearable device is determined at a rear seat of a vehicle.

8. The control method according to claim 7, further comprising receiving a command from the wearable device and performing operation corresponding to the received command.

9. The control method according to claim 1, further comprising communicating with the wearable device.

10. An AVN terminal comprising:
an interface unit communicating with a wearable device; and
a controller determining a position of the wearable device and providing a service based on the position of the wearable device.

11. The AVN terminal according to claim 10, wherein the controller controls the interface unit so as to await reception of a remote control command from the wearable device when the wearable device is determined at the outside of a vehicle.

12. The AVN terminal according to claim 11, wherein the remote control command includes at least one of a remote start command, a remote air conditioning command, and remote door lock and unlock commands.

13. The AVN terminal according to claim 10, wherein the controller provides a guide service to guide the way to a destination when the wearable device is determined at a driver seat of a vehicle and the destination is set in the AVN terminal.

14. The AVN terminal according to claim 10, wherein the controller is configured to provide a multimedia service when the wearable device is determined at a passenger seat of a vehicle.

15. The AVN terminal according to claim 10, wherein the controller is configured to power ON a rear seat entertainment (RSE) terminal corresponding to a rear seat of a vehicle when the wearable device is determined at the rear seat.

16. The AVN terminal according to claim 10, further comprising a display,
wherein the controller is configured to control the display so as to display content in a simple mode when the wearable device is determined at a rear seat of a vehicle.

17. The AVN terminal according to claim 16, wherein the AVN terminal is configured to perform operation corresponding to a specific command upon receiving the specific command from the wearable device.

18. A control method of a wearable device, the method comprising:
transmitting a position of the wearable device to an audio video navigation (AVN) terminal;
receiving a specific control command corresponding to the position from the AVN terminal; and
operating in response to the control command received from the AVN terminal.

19. The control method according to claim 18, wherein the receiving includes receiving a command for remote control of the AVN terminal when the position is at the outside of a vehicle, and
wherein the operating includes displaying a user interface (UI) for remote control of the AVN terminal.

20. The control method according to claim 19, wherein the UI for remote control includes at least one item among a remote start item, a remote air conditioning item, and remote door lock and unlock items.

21. The control method according to claim 20, further comprising, upon selection of at least one item, transmitting a control command corresponding to the selected item to the AVN terminal.

22. A wearable device comprising:
a modem transmitting a position of the wearable device to an audio video navigation (AVN) terminal; and
a controller controlling the modem so as to receive a control command corresponding to the position from the AVN terminal,
wherein the controller performs operation in response to the control command received from the AVN terminal.

23. A computer readable recording medium including a program to execute a control method of an audio video navigation (AVN) terminal, wherein the control method comprises:
determining a position of a wearable device; and
providing a service based on the position of the wearable device.
